(19) United States
(12) Patent Application Publication
(10) Pub. No.: US 2026/0238344 A1
(43) Pub. Date: Aug. 13, 2026

(54) CALCULATION DEVICE, CALCULATION METHOD AND PROGRAM

(71) Applicant: NTT, Inc., Tokyo (JP)

(72) Inventors: Kenta HIROSE, Tokyo (JP); Hiroki SAKUMA, Tokyo (JP); Takafumi FUKATANI, Tokyo (JP); Masahiro NAKAGAWA, Tokyo (JP); Takeshi SEKI, Tokyo (JP); Takashi MIYAMURA, Tokyo (JP)

(73) Assignee: NTT, Inc., Tokyo (JP)

(21) Appl. No.: 19/156,414

(22) PCT Filed: Feb. 21, 2023
(86) PCT No.: PCT/JP2023/006200

§ 371 Date: Aug. 14, 2025

(51) Int. Cl. H04B 10/2537; H04B 10/2507

(52) U.S. Cl. CPC H04B 10/2537; H04B 10/25073

(57) ABSTRACT

A calculation device calculates input power to an optical fiber transmission line of each channel in two adjacent bands. The calculation device calculates the input power for eliminating an inclination of signal quality by using a coefficient indicating the inclination of an input power spectrum by assuming that power transition in the transmission line due to an influence of stimulated Raman scattering depends on the number of existing channels in the optical fiber transmission line. The calculation device can calculate how much it is optimum to lift the input power in a short wavelength band in advance in order to make signal quality constant from the short wavelength band to a long wavelength band on an incoming side.

### CROSS-REFERENCE TO RELATED APPLICATION

This is a National Stage Application of PCT Application No. PCT/JP2023/006200, filed on Feb. 21, 2023. The disclosure of the prior application is considered part of the disclosure of this application, and is incorporated in its entirety into this application.

### BACKGROUND

### Technical Field

The present invention relates to a calculation device, a calculation method and a program.

### Background Art

As one optical fiber nonlinear optical effect generated in wavelength multiplexing transmission, power transition between channels (wavelengths) by stimulated Raman scattering (SRS) is known (for example, see NPL 1 to NPL 4).

FIG. 6A is a conceptual diagram of power transition between channels. The first horizontal axis represents a frequency and the second horizontal axis represents a wavelength. Here, it is assumed that input power of each channel is equal. A value of a channel (channel i) is small on the right side and is large on the left side of the horizontal axis. A channel adjacent to the high frequency short wavelength side (right) when viewed from the channel i is a channel i−1. A channel adjacent to the low frequency long wavelength side (left) when viewed from the channel i is a channel i+1. Note that a value of a wavelength corresponding to the channel is small on the right side and is large on the left side of the horizontal axis (λᵢ₊₁>λᵢ>λᵢ₋₁). Conversely, a value of a frequency is large on the right side and is small on the left side of the horizontal axis (fᵢ₊₁<fᵢ<fᵢ₋₁).

An optical signal of each channel is transmitted through an optical fiber over a predetermined span length. At this time, power Pᵢ₋₁ or the like of a channel adjacent to the higher frequency short wavelength side (right) rather than the channel i transitions to power Pᵢ side of the channel i due to the SRS. In addition, the power Pᵢ of the channel i transitions to the power Pᵢ₊₁ side of a channel adjacent to the low frequency long wavelength side (left).

Therefore, post-transmission power of each channel varies in signal quality depending on the wavelength. For example, as shown in FIG. 6B, the post-transition power Pᵢ₋₁ or the like of the channel adjacent to the higher frequency short wavelength side (right) rather than the channel i increases in loss as the frequency becomes higher. In addition, the post-transmission power Pᵢ₊₁ or the like of the channel adjacent to the lower frequency long wavelength side (left) rather than the channel i decreases in loss as the frequency becomes lower. Therefore, as shown by a two-dot chain line in FIG. 6B, a right downward inclination (tilt) is generated in a spectrum of the post-transmission power of each channel.

### RELATED ART

### Non Patent Literature

[NPL 1] Kenta Hirose, Takafumi Fukatani, Masahiro Nakagawa, Takeshi Seki, Takashi Miyamura, “Analysis of Stimulated-Raman-Scattering Effect Changed by the Number of Optical Channels on Multiband Wavelength-Division-Multiplexed Networks” IEICE Tech. Rep., vol. 121, No. 386, PN2021-57, pp. 29 to 32, March 2022.
[NPL 2] DANIEL SEMRAU, ROBERT KILLEY, POLINA BAYVEL, “Achievable rate degradation of ultra-wideband coherent fiber communication systems due to stimulated Raman scattering”, Optics Express, vol. 25, no. 12, 13024-13034, June 2017.
[NPL 3] Hiroki Kawahara, Kohei Saito, Sachio Suda, Takeshi Seki, and Hideki Maeda, “Cancellation of Static and Dynamic Power Transitions induced by inter-band Stimulated Raman Scattering in C+L-band WDM Transmission”, 25th OptoElectronics and Communications Conference, Taipei, Taiwan, October 2020.
[NPL 4] Fukutaro Hamaoka, Kyo Minoguchi, Takeo Sasai, Asuka Matsushita, Masanori Nakamura, Seiji Okamoto, Etsushi Yamazaki, and Yoshiaki Kisaka, “150.3-Tb/s Ultra-Wideband (S, C, and L Bands) Single-Mode Fibre Transmission over 40-km Using >519 Gb/s/k PDM-128QAM Signals”, 44th European Conference on Optical Communication, Rome, Italy, September 2018.

### SUMMARY OF INVENTION

### Technical Problem

In a conventional dense wavelength division multiplexing (DWDM) using a single band, that is, a wavelength band of a C band (Conventional band) or an L band (Long wavelength band), it can be said that an influence of power transition between channels is negligible. Note that the (wavelength and frequency) of the C band is in the range of (1530 to 1565 nm and 191.56 to 195.94 THz). The (wavelength and frequency) of the L band is in the range of (1565 to 1625 nm and 184.49 to 191.56 THz). Accordingly, a wavelength band of the C band or the L band is about a width of 4.8 THz.

On the other hand, when DWDM using a multi-band such as a C+L band (about a width of 10 THz) is assumed, the influence of power transition between channels becomes apparent, and a problem such as a variation in signal quality due to wavelength arises. For example, when the power of the C band shifts to the L band side during light propagation, an excessive loss occurs in the C band, and the signal power decreases too much at a light arrival point. Therefore, conventionally, a technique for strengthening input power of light in a short wavelength band where the power transition occurs and making the reception power constant from the short wavelength band to the long wavelength band on a reception side (output side) has been proposed. However, in the conventional technique, for example, it is necessary to examine a ratio of change in the reception power by an experiment and to take countermeasures such as adjustment of input power (transmission power) for each wavelength based on the value. In the conventional technique, in the DWDM using two adjacent bands, it is impossible to optimize the input power of the optical fiber transmission line so that the signal quality at the time of transmission is equalized and maximized.

Therefore, in the present invention, it is a problem to solve the above-described problem and calculate the input power for eliminating the inclination of signal quality at the time of transmission in the DWDM using two adjacent bands.

### Solution to Problem

It is characterized in that a calculation device according to the present invention is a calculation device that calculates input power to an optical fiber transmission line of each channel in two adjacent bands, and calculates the input power for eliminating an inclination of signal quality by using a coefficient indicating an inclination of an input power spectrum by assuming that power transition in the transmission line due to an influence of stimulated Raman scattering depends on the number of existing channels in the optical fiber transmission line.

### Advantageous Effects of Invention

According to the present invention, it is possible to calculate the input power for eliminating the inclination of signal quality at the time of transmission in the DWDM using two adjacent bands.

### BRIEF DESCRIPTION OF DRAWINGS

FIG. 1 is a schematic configuration diagram of a system including a calculation device according to an embodiment.

FIG. 2A is a schematic diagram of a wavelength multiplexing network.

FIG. 2B is a schematic diagram of a power spectrum.

FIG. 3A is a flowchart showing a flow of processing of a calculation device according to a first embodiment.

FIG. 3B is a flowchart showing a flow of processing of a calculation device according to a second embodiment.

FIG. 4 is a graph showing signal quality according to an example and a comparative example.

FIG. 5 is a hardware configuration diagram showing one example of a computer that realizes functions of the calculation device according to the embodiment.

FIG. 6A is a conceptual diagram of power transition between channels.

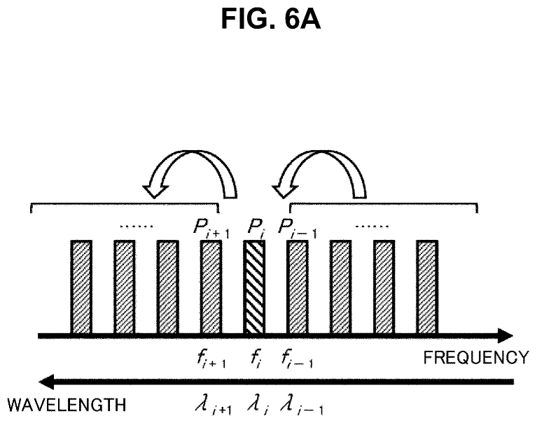

FIG. 6B is a conceptual diagram of an inclination of power spectrum.

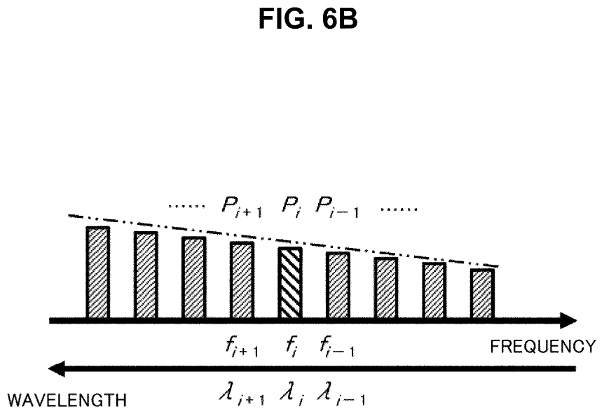

### DESCRIPTION OF EMBODIMENTS

Hereinafter, a calculation device according to a present embodiment will be described in detail with reference to the drawings.

### [Outline of System Configuration]

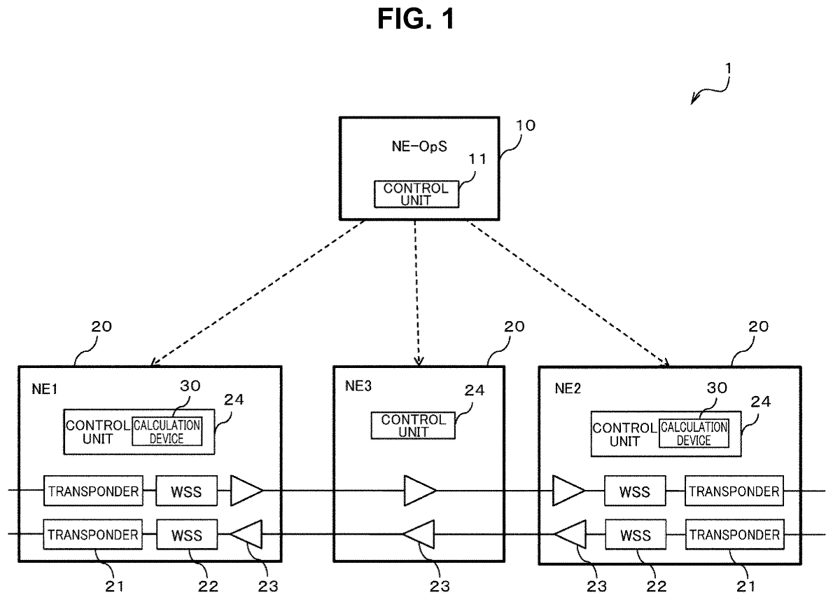

As shown in FIG. 1, an optical transmission system 1 includes a network facility monitor device 10 and a network device 20. The network facility monitor device 10 is configured by a NE-OpS (Network element operation system), for example. The network facility monitor device 10 includes a control unit 11 that monitors the network device 20.

The network device 20 is an optical transmission device such as a ROADM (Reconfigurable Optical Add/Drop Multiplexer), for example. The network device 20 includes a transponder 21, a wavelength selective switch (WSS) 22, an optical amplification unit 23, and a control unit 24, for example. The number of network devices 20 is arbitrary. When three network devices shown in FIG. 1 are distinguished, the network devices are denoted as NE1, NE2, and NE3, and when the network devices are not distinguished, the network devices are denoted as the network device 20.

For example, when an electrical signal from an external communication device is inputted to the transponder 21 of the network device NE1, this electrical signal is converted into an optical signal by the transponder 21, multiplexed by the wavelength selective switch 22, amplified by the optical amplification unit 23, and then transmitted to the outside. This optical signal is amplified by the optical amplification unit 23 of the network device NE3, for example. This amplified optical signal is amplified by the optical amplification unit 23 of the network device NE2, demultiplexed by the wavelength selective switch 22, received by the transponder 21, and transmitted to the communication device not shown, for example. Note that this optical transmission system 1 performs bidirectional communication. In addition, the network device NE3 is a device specialized in amplification of optical signals.

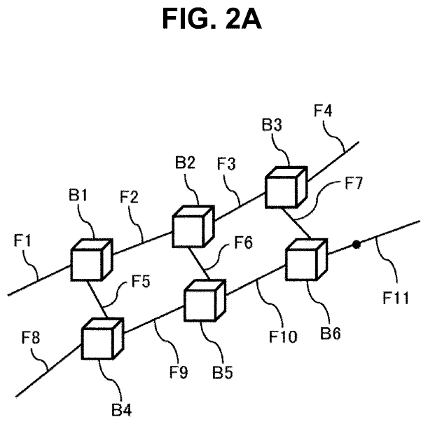

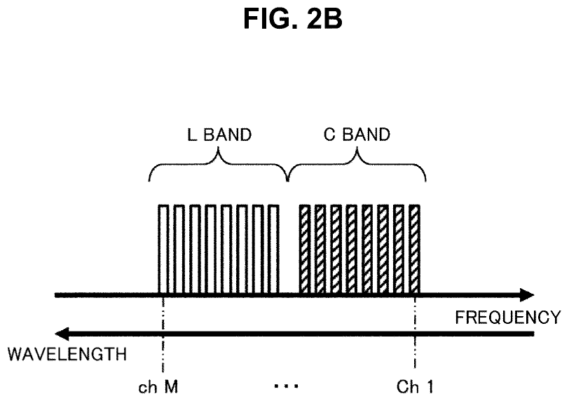

As shown in FIG. 2A, optical fiber transmission lines F1 to F11 are laid between a plurality of buildings B1 to B6, and a wavelength multiplexing network is formed. At least one network device 20 is located in each of the buildings B1 to B6.

The network device 20 includes a calculation device 30. Here, the control unit 24 of NE1 and NE2 which are optical transmission devices such as ROADMs includes the calculation device 30 (see FIG. 1).

The calculation device 30 calculates input power to the optical fiber transmission line of each channel in two adjacent bands. The calculation device 30 calculates the input power for eliminating an inclination of signal quality by using a coefficient indicating an inclination of input power spectrum by assuming that power transition in the transmission line due to an influence of stimulated Raman scattering depend on the number of existing channels in the optical fiber transmission line. The calculation device 30 does not require optimization by iterative calculation.

The calculation device 30 performs the calculation of the input power of each channel based on the relational expression of transmission line fiber input power. The relational expression of the transmission line fiber input power is obtained by correlating the transmission line fiber input power ratio of adjacent channels as the coefficient indicating the inclination of input power spectrum. The relational expression of the transmission line fiber input power is based on an OSNR which is a parameter of signal quality expressed by assuming that a loss coefficient of the transmission line fiber and the noise index of the amplifier are uniform with respect to the frequency. In the relational expression of the transmission line fiber input power, the incoming power for each span can be equalized. Note that the OSNR is an abbreviation of Optical Signal to Noise Ratio.

For example, the calculation device 30 can perform the calculation of the input power of each channel based on a following mathematical Expression (2) by assuming that a signal quality parameter is the OSNR represented by a following mathematical Expression (1).

$$\begin{matrix}[ Math . 1 ] & \\ & ( 1 )\end{matrix}$$

$${OSNR}_{i} [ dB ] = {P}_{i} [ dBm ] - {LOSS}_{i} [ dB ] - F [ dB ] - 10 log ( N + 1 ) - 10 log ( h {f}_{i} {f}_{r} )$$

$${P}_{i} = \frac{2 α ( r - 1 ) ln r}{k f ( 1 - {e}^{- α L} ) ( {ρ}_{1} + {ρ}_{2} {r}^{\frac{M}{2}} ) ( 1 - {r}^{\frac{M}{2}} )} {r}^{\frac{{f}_{1} - {f}_{i}}{f}} \qquad ( 2 )$$

Here, i: channel number (highest frequency when i=1 is satisfied), OSNRᵢ: OSNR of channel i, Pᵢ: transmission line fiber input power [W] of channel i, LOSSᵢ: span loss (including influence of stimulated Raman scattering) of channel i, F: noise index of amplifier, N: number of spans, h: Planck constant [mJ s], fᵢ: frequency [THz] of channel i, fᵣ: frequency [THz] of noise band width, α: loss coefficient [km⁻¹] of transmission line fiber, r: coefficient indicating inclination of input power spectrum and transmission line fiber input power ratio of adjacent channels, k: inclination [km⁻¹ W⁻¹ THz⁻¹] of Raman gain coefficient, f: channel interval [THz], L: span length [km], ρᵢ: utilization factor of band 1, ρ₂: utilization factor of band 2, and M: maximum number of channels. Note that prefixes m, T, and k in the unit represent 10⁻³, 10¹², and 10³, respectively.

The two adjacent bands are constituted of an L band and a C band as shown in FIG. 2B as one example. Channel 1 (ch 1) is set to the C band, and channel M (ch M) is set to the L band. In this example, the band 1 is the C band and the band 2 is the L band in order from the high frequency side.

Note that the two adjacent bands may be constituted of the C band and the S band. The (wavelength and frequency) of the S band is in the range of (1460 to 1530 nm and 195.94 to 205.34 THz). In this example, the band 1 is the S band and the band 2 is the C band in order from the high frequency side.

In addition, the two adjacent bands may be constituted of a U band (Ultralong wavelength band) and the L band. In this example, the band 1 is the L band and the band 2 is the U band in order from the high frequency side. The (wavelength and frequency) of the U band is in the range of (1625 to 1675 nm and 178.97 to 184.49 THz).

In the optical transmission system 1, the type of optical fiber transmission line is not particularly limited. As the type of optical fiber transmission line, G.652 SMF (single mode optical fiber), G.653 DSF (Dispersion-shifted fiber), and G.654 CSF (Cut-off shifted fiber) can be used, for example. In the optical transmission system 1, the span length is not particularly limited. The span length can be set to 0 to 1000 km, for example.

The optical transmission system 1 can use an optical fiber for submarine system or an optical fiber for land system, for example. In the present embodiment, the optical transmission system 1 is configured to correspond to variations in the number of existing channels in the optical fiber transmission line, particularly required in the land system. Note that the channel arrangement in each band is not limited. Flexible grid is handled by replacing the channel with the grid.

An adjustment of the optical fiber transmission line input power is performed by one or all of the amplifier, the attenuator, and the wavelength selective switch by control via an interface from the network facility monitor device 10, for example. Here, the amplifier, the attenuator, and the wavelength selective switch can be set to equipment corresponding to a plurality of bands, or equipment corresponding to a single band. When multiplexing and demultiplexing of the plurality of bands are required, either or both of a coupler and the wavelength selective switch are used. Note that the adjustment of the optical fiber transmission line input power may be configured to be performed by one or all of the amplifier, the attenuator, and the wavelength selective switch by the control via the interface from an EMS (Element Management System) not shown.

The network device 20 may be a transmission device having any or all functions of adding, drop, and cross-connecting, for example.

The control unit 24 of the network devices NE1 and NE2 includes the calculation device 30, but is not limited to this. For example, the control unit 24 of the network device NE3 may include the calculation device 30. In addition, the control unit 11 of the network facility monitor device 10 or the EMS not shown may include the calculation device 30.

### First Embodiment

A calculation device 30 according to a first embodiment searches for and determines a coefficient indicating the inclination of input power spectrum under a condition that the GSNR of the highest frequency channel is the maximum value when the incoming OSNR is uniform and the highest frequency channel is the highest input power among all channels based on the GSNR when the incoming OSNR is uniform. The calculation device 30 computes transmission line fiber input power for all the channels by using the determined coefficient. Note that the GSNR is an abbreviation of Generalized signal-to-noise ratio. The calculation device 30 uses a following mathematical Expression (3) as the GSNR when the incoming OSNR is uniform, for example. Here, the highest frequency channel is assumed to be a channel 1. It is assumed that the coefficient indicating the inclination of input power spectrum is the transmission line fiber input power ratio r.

$$\begin{matrix}[ Math . 2 ] & \\ {GSNR}_{i} = \frac{{P}_{i}}{{P}_{A S E , i} + {P}_{N L I , i}} & ( 3 )\end{matrix}$$

$$where$$

$${P}_{ASE , i} = {Fhf}_{i} {fe}^{{α}_{i} L} , \qquad ( 4 )$$

$${P}_{NLI , i} = {η}_{i} {P}_{i}^{3} , \qquad ( 5 )$$

$${α}_{0 , i} = α - \frac{α ln r}{1 - {e}^{- α L}} ( \frac{M}{2} {r}^{\frac{M}{2}} ( \frac{{ρ}_{2}}{{ρ}_{1} + {ρ}_{2} {r}^{\frac{M}{2}}} - \frac{1}{1 - {r}^{\frac{M}{2}}} ) + \frac{1}{1 - r} - i ) , \qquad ( 6 )$$

$${α}_{i} = \frac{( {α}_{0 , i} - α ) \frac{1 - {e}^{- α L}}{α} + α L}{L} , \qquad ( 7 )$$

$${η}_{i} = \frac{8}{27} {{γ}^{2} ( \frac{1 - {e}^{- {α}_{i} L}}{{α}_{i}} )}^{2} {α}_{i} \frac{a sinh \frac{\frac{{π}^{2}}{2} \vert {β}_{2} \vert {f}^{2} {M}^{2}}{{α}_{i}}}{π \vert {β}_{2} \vert {f}^{2}} \qquad ( 8 )$$

Here, GSNRᵢ: GSNR of channel i, P_{ASE, i}. linear noise power [W] of channel i, P_{NLI, i}. nonlinear noise power [W] of channel i, h: Planck constant [J s], α_{0, i}: loss coefficient [km⁻¹] immediately after transmission line fiber input of channel i, αᵢ: loss coefficient [km⁻¹] averaged on transmission line fiber longitudinal direction of channel i, ηᵢ: nonlinear noise coefficient [W⁻²] of channel i, γ: nonlinear coefficient [km⁻¹ W⁻¹], and β₂: group velocity dispersion [ps² km⁻¹]. Note that the prefix p in the unit is 10⁻¹².

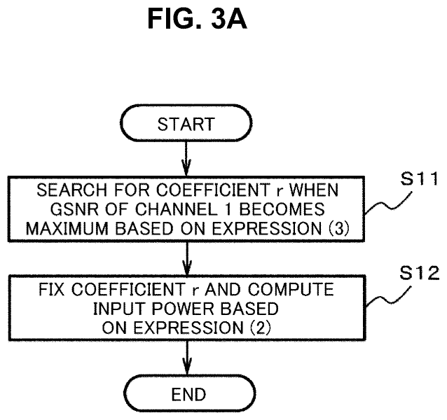

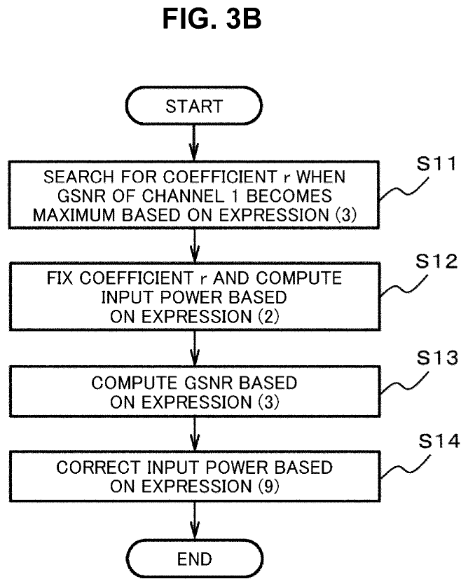

As shown in FIG. 3A, the calculation device 30 according to the first embodiment first searches for the coefficient r when the GSNR of the channel 1 becomes maximum based on the mathematical Expression (3) (step S11). Then, the calculation device 30 fixes the coefficient r to compute the input power based on the mathematical Expression (2) (step S12). Note that the calculation device 30 according to the first embodiment can also compute the GSNRs for all the channels based on the mathematical Expression (3) by using the input power computed for all the channels.

### Second Embodiment

A calculation device 30 according to a second embodiment adjusts the input power computed by the calculation device 30 according to the first embodiment to compute the corrected input power. The calculation device 30 according to the second embodiment uses, for the calculation, the coefficient determined by searching, the transmission line fiber input power for all the channels computed based on the relational expression of the transmission line fiber input power, and the GSNRs for all the channels when the incoming OSNR is uniform. The calculation device 30 fixes the optical fiber transmission line input power of the highest frequency channel and adjusts the optical fiber transmission line input power of each channel so as to cancel the GSNR difference between the channels to compute the corrected input power.

For example, the calculation device 30 according to the second embodiment substitutes r determined by the calculation device 30 according to the first embodiment, transmission line fiber input power Pᵢ for all the channels computed based on the mathematical Expression (2), and the GSNRᵢ computed for all the channels based on the mathematical Expression (3) into the right side of a following mathematical Expression (9) to compute the corrected input power. Note that the accent of P on the left side of the mathematical Expression (9) is a hat. The hat Pᵢ is the input power obtained by correcting Pᵢ. ln r represents a natural logarithm of r.

$$\begin{matrix}[ Math . 3 ] & \\ {\hat{P}}_{i} = {P}_{i} \cdot {( \frac{{GSNR}_{1}}{{GSNR}_{i}} )}^{\frac{1}{1 - ( \frac{M}{2} {r}^{\frac{M}{2}} ( \frac{{ρ}_{2}}{{ρ}_{1} + {ρ}_{2} {r}^{\frac{M}{2}}} - \frac{1}{1 - {r}^{\frac{M}{2}}} ) + \frac{1}{1 - r} ) l nr}} & ( 9 )\end{matrix}$$

As shown in FIG. 3B, the calculation device 30 according to the second embodiment computes the GSNR based on the mathematical Expression (3) following steps S11 and S12 (step S13). Then, the calculation device 30 corrects the input power based on the mathematical Expression (9) (step S14).

The calculation device 30 can compute the input power for eliminating the inclination of signal quality in consideration of a change in stimulated Raman scattering amount by using the mathematical Expression (9). Note that the calculation device 30 can also compute the GSNRs for all the channels based on the mathematical Expression (3) by using the input power corrected for all the channels.

Next, two simulations performed to confirm an effect of the calculation device 30 will be described in order.

### (First Simulation)

A first simulation is an experiment for verifying the effect of eliminating the inclination of signal quality by the calculation device 30 according to the first embodiment. As the simulation conditions, the maximum number M of channels is set to 160. Note that the maximum number M of channels is the maximum value of the number of channels to be set.

In 192.15 to 196.10 THz of the C band, the frequency fᵢ of the number of channels 80 (channel numbers 1 to 80) is set with a center frequency interval f=50 [GHz].

In 186.55 to 190.50 THz of the L band, the frequency fᵢ of the number of channels 80 (channel numbers 81 to 160) is set with a center frequency interval f=50 [GHz].

The calculation device 30 of the first embodiment computes the transmission line fiber input power Pᵢ for all the channels under the condition that the GSNR₁ of the channel 1 becomes the maximum value based on the mathematical Expression (3). Note that the transmission line fiber input power Pᵢ is obtained by previously raising the input power of the short wavelength band and is inclined. Next, for verification, the GSNRᵢ is computed for all the channels again based on the mathematical Expression (3) by using this Pᵢ. The result at this time is set as an example 1. On the other hand, the GSNR is computed in the case where the input power is flat. The result at this time is set as a comparative example 1.

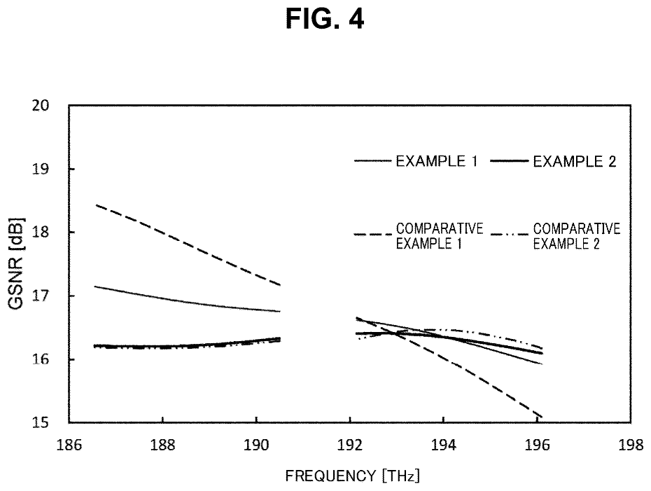

FIG. 4 is a graph showing the first simulation result. The horizontal axis of graph indicates the frequency, and the vertical axis indicates the GSNR. In the graph, the thin line indicates the example 1, and the broken line indicates the comparative example 1. In the comparative example 1, for example, in the channel number 160 (186.55 THz), the GSNR is 18.4 dB, and in the channel number 81 (190.50 THz), the GSNR is 17.2 dB, and the difference between them is 1.2 dB. In addition, in the channel number 80 (192.15 THz), the GSNR is 16.7 dB, and in the channel number 1 (196.10 THz), the GSNR is 15.1 dB, and the difference between them is 1.6 dB.

In the example 1, for example, the channel number 160 (186.55 THz), the GSNR is 17.1 dB, and the channel number 81 (190.50 THz), the GSNR is 16.8 dB, and the difference between them is 0.3 dB. IN addition, in the channel number 80 (192.15 THz), the GSNR is 16.6 dB, and in the channel number 1 (196.10 THz), the GSNR is 15.9 dB, and the difference between them is 0.7 dB. In the example 1, the minimum GSNR is 15.9 dB.

As shown in FIG. 4, in the comparative example 1, since no contrivance is taken, the inclination of signal quality occurs. In the example 1, the inclination of signal quality is clearly eliminated. In addition, the example 1 shows a good result that a variation in signal quality due to the wavelength can be improved.

Note that, as a reference, the GSNR obtained by entire search optimization of the offset tilt method is computed. The result at this time is set as a comparative example 2. In the graph of FIG. 4, the two-dot chain line indicates the comparative example 2. In the comparative example 2, for example, in the channel number 160 (186.55 THz), the GSNR is 16.2 dB, and in the channel number 81 (190.50 THz), the GSNR is 16.3 dB, and the difference between them is −0.1 dB. In addition, in the channel number 80 (192.15 THz), the GSNR is 16.3 dB, and in the channel number 1 (196.10 THz), the GSNR is 16.2 dB, and the difference between them is 0.1 dB. In the comparative example 2, the minimum GSNR is 16.2 dB.

Therefore, the minimum GSNR (15.9 dB) in the example 1 is lower than the GSNR (16.2 dB) of the lowest quality channel obtained from the comparative example 2. This suggests that there is room for improving the signal quality by relaxing the condition of the incoming OSNR uniformity in the example 1. That is, it is predicted that the calculation device 30 of the second embodiment in which the conditions of the incoming OSNR uniformity are relaxed further improves the signal quality.

### (Second Simulation)

A second simulation is an experiment for verifying the effect of eliminating the inclination of signal quality by the calculation device 30 according to the second embodiment. The simulation conditions are the same as those of the first simulation. The calculation device 30 of the second embodiment adjusts the input power computed by the calculation device 30 according to the first embodiment based on the mathematical Expression (9), and computes the corrected input power. Next, for verification, the GSNRᵢ is computed for all the channels again based on the mathematical Expression (3) by using the corrected input power. This result is set as an example 2.

FIG. 4 also shows the result of the second simulation. In the graph, the bold line indicates the example 2. In the example 2, for example, in the channel number 160 (186.55 THz), the GSNR is 16.2 dB, and in the channel number 81 (190.50 THz), the GSNR is 16.3 dB, and the difference between them is −0.1 dB. In addition, in the channel number 80 (192.15 THz), the GSNR is 16.4 dB, and in the channel number 1 (196.10 THz), the GSNR is 16.1 dB, and the difference between them is 0.3 dB. In the example 2, the minimum GSNR is 16.1 dB.

As shown in FIG. 4, the example 2 shows a good result that the inclination of signal quality is eliminated similarly to the example 1 and a variation in signal quality due to the wavelength can be improved. In addition, in the example 2, the spectrum of signal quality becomes flatter.

The calculation device 30 according to the second embodiment can maximize the GSNR of the lowest quality channel by lowering the input power of the channel having excessive GSNR in the example 1 to equalize the GSNR by the operation based on the mathematical Expression (9). Two reasons for this can be given.

The first reason is that the operation of correcting the input power Pᵢ based on the mathematical Expression (9) hardly changes the nonlinear influence (P_{NLI, i}). By this operation, the input power of the high frequency side channel having the large Pᵢ hardly changes. In addition, the low frequency side channel having the small Pᵢ have small nonlinear influence originally. Note that the P_{NLI, i} is included in the denominator of the right side of the mathematical Expression (3) and are defined by a mathematical Expression (5). ηᵢ of the right side of the mathematical Expression (5) is defined by a mathematical Expression (8).

The second reason is that this operation changes a generation amount of stimulated Raman scattering. The generation amount of stimulated Raman scattering can be described by a relational expression with the total input power.

Therefore, the amount obtained by subtracting the change amount of the induced Raman scattering generation amount from the change amount of Pᵢ becomes an amount for reducing the GSNR difference. In the example 2, since the power of the low frequency side channel is reduced, the power in which Pᵢ is taken away by stimulated Raman scattering is reduced, and the GSNR₁ is improved.

### [Hardware Configuration]

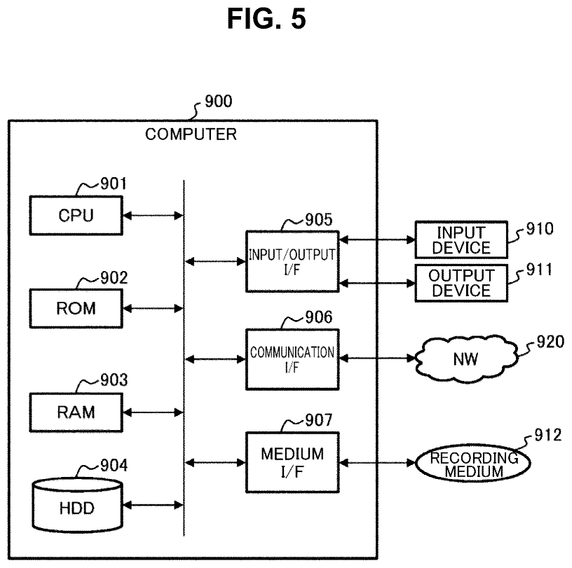

The calculation device 30 according to each embodiment is realized by a computer 900 that has a configuration as shown in FIG. 5, for example. FIG. 5 is a hardware configuration diagram showing one example of the computer 900 that realizes functions of the calculation device 30 according to the present embodiment. The computer 900 has a CPU (Central Processing Unit) 901, a ROM (Read Only Memory) 902, a RAM (Random Access Memory) 903, an HDD (Hard Disk Drive) 904, an input/output I/F (Interface) 905, a communication I/F 906, and a medium I/F 907.

The CPU 901 operates based on a program stored in the ROM 902 or the HDD 904. The ROM 902 stores a boot program executed by the CPU 901 when the computer 900 is started, a program related to hardware of the computer 900, and the like.

The CPU 901 controls an input device 910 such as a mouse or a keyboard, and an output device 911 such as a display or a printer through the input/output I/F 905. The CPU 901 acquires data from the input device 910, and outputs generated data to the output device 911 through the input/output I/F 905. Note that a GPU (Graphics Processing Unit) or the like may be used as a processor together with the CPU 901.

The HDD 904 stores programs executed by the CPU 901, data used by the programs, and the like. The communication I/F 906 receives data from other devices and outputs the data to the CPU 901 through a communication network 920, and transmits data generated by the CPU 901 to other devices through the communication network 920.

The medium I/F 907 reads the program or data stored in a recording medium 912 and outputs the read program or data to the CPU 901 through the RAM 903. The CPU 901 loads the program related to target processing from the recording medium 912 onto the RAM 903 through the medium I/F 907, and executes the loaded program. The recording medium 912 is an optical recording medium such as a DVD (Digital Versatile Disc) or a PD (Phase change rewritable Disk), a magneto optical recording medium such as an MO (Magneto Optical disk), a magnetic recording medium, a semiconductor memory, or the like.

For example, when the computer 900 functions as the calculation device 30 according to each embodiment, the CPU 901 realizes the functions of the calculation device 30 by executing the program loaded onto the RAM 903. In addition, the HDD 904 stores data in the RAM 903. The CPU 901 reads the program related to target processing from the recording medium 912, and executes the program. In addition, the CPU 901 may read the program related to the target processing from other devices through the communication network 920.

### Effects

As described above, it is characterized in that the calculation device is a calculation device 30 that calculates the input power to the optical fiber transmission line of each channel in the two adjacent bands, and calculate the input power for eliminating the inclination of signal quality by using the coefficient r indicating the inclination of input power spectrum by assuming that power transition in the transmission line due to the influence of stimulated Raman scattering depends on the number of existing channels in the optical fiber transmission line.

By doing this, the calculation device 30 obtains the input power of each channel in the two adjacent bands by the calculation. Accordingly, in order to make the signal quality constant from the short wavelength band to the long wavelength band on the incoming side, the calculation device 30 can calculate how much it is optimum to lift the input power in the short wavelength band in advance.

It is characterized in that the calculation device 30 executes the calculation of the input power of each channel based on the relational expression for the transmission line fiber input power that equalize the incoming power for each span based on the OSNR which is a parameter of signal quality expressed by assuming that the loss coefficient of the transmission line fiber and the noise index of the amplifier are uniform with respect to the frequency and in the relational expression, the transmission line fiber input power ratio of adjacent channels is related as the coefficient indicating the inclination of input power spectrum.

By doing this, the calculation device 30 calculates the input power of each channel in the two adjacent bands based on the relational expression of the transmission line fiber input power. In the relational expression of the transmission line fiber input power, the transmission line fiber input power ratio of adjacent channels is related as the coefficient indicating the inclination of input power spectrum, and since the incoming power of each span is equalized, the incoming OSNR can be equalized. The calculation device 30 can calculate the input power for eliminating the inclination of the signal quality in the DWDM by using an appropriate coefficient to the relational expression of the transmission line fiber input power.

It is characterized in that the calculation device 30 searches for and determines the coefficient under the condition that the GSNR of the highest frequency channel becomes the maximum value when the incoming OSNR is uniform and the highest frequency channel is the highest input power among all the channels based on the GSNR when the incoming OSNR is uniform, and computes the transmission line fiber input power for all the channels by using the determined coefficient.

When the incoming OSNR is uniform and the highest frequency channel is the highest input power among all the channels, the nonlinear influence on the highest frequency channel is always maximum among all the channels. Therefore, when the incoming OSNR is uniform, the GSNR of the highest frequency channel is always minimum among all the channels. Since searching for the coefficient under the condition that the GSNR of the highest frequency channel becomes the maximum value at this time, the calculation device 30 equalizes the signal quality and maximizes it. That is, the calculation device 30 maximizes the signal quality of the lowest signal quality channel. The input power computed based on the relational expression by using the coefficient determined at this time becomes the input power for eliminating the inclination of signal quality. Therefore, according to the calculated input power, it is possible to flatten the signal quality having such an inclination that the GSNR of the channel usually increases as the frequency becomes lower.

It is characterized in that the calculation device 30 fixes the optical fiber transmission line input power of the highest frequency channel, and adjusts the optical fiber transmission line input power of each channel so as to cancel the GSNR difference between the channels to compute the corrected input power by using the determined coefficient, the transmission line fiber input power for all the channels computed based on the relational expression, and the GSNRs for all the channels when the incoming OSNR is uniform.

By doing this, the calculation device 30 fixes the optical fiber transmission line input power of the highest frequency channel and adjusts the optical fiber transmission line input power of each channel so as to cancel the GSNR difference between the channels and thus can decrease the input power of a channel in which the GSNR is excessive. Therefore, the calculation device 30 can equalize the signal quality and maximize it.

It is characterized in that a calculation method is a calculation method of the calculation device 30 that calculates the input power to the optical fiber transmission line of each channel in the two adjacent bands, and the calculation device 30 calculates the input power for eliminating the inclination of signal quality by using the coefficient indicating the inclination of input power spectrum by assuming that power transition in the transmission line due to the influence of stimulated Raman scattering depends on the number of existing channels in the optical fiber transmission line.

By doing this, the calculation device 30 obtains the input power of each channel in the two adjacent bands by the calculation. Accordingly, the calculation device 30 can calculate how much it is optimum to lift the input power in the short wavelength band in advance in order to make the signal quality and the incoming power constant from the short wavelength band to the long wavelength band on the incoming side.

Note that the present invention is not limited to the embodiment described above, and various modifications can be made by a person of ordinary skill in the art within the technical idea of the present invention.

1. A calculation device, comprising:
circuitry configured to calculate input power to an optical fiber transmission line of each channel in two adjacent bands,
wherein the circuitry calculates the input power for eliminating an inclination of signal quality by using a coefficient indicating an inclination of an input power spectrum by assuming that power transition in the transmission line due to an influence of stimulated Raman scattering depends on a number of existing channels in the optical fiber transmission line.

2. The calculation device according to claim 1, wherein:
the circuitry execute a calculation of the input power of each channel based on a relational expression for transmission line fiber input power that equalizes incoming power for each span based on an OSNR which is a parameter of signal quality expressed by assuming that a loss coefficient of the transmission line fiber and a noise index of an amplifier are uniform with respect to a frequency, and
in the relational expression, a transmission line fiber input power ratio of adjacent channels is related as the coefficient indicating the inclination of input power spectrum.

3. The calculation device according to claim 2, wherein:
the circuitry searches for and determines the coefficient under a condition that a GSNR of a highest frequency channel is a maximum value when an incoming OSNR is uniform and the highest frequency channel is the highest input power among all channels based on the GSNR when the incoming OSNR is uniform and computes the transmission line fiber input power for all the channels by using the determined coefficient.

4. The calculation device according to claim 3, wherein:
the circuitry fixes the optical fiber transmission line input power of the highest frequency channel, and adjusts the optical fiber transmission line input power of each channel so as to cancel a GSNR difference between the channels to compute the corrected input power by using the determined coefficient, the transmission line fiber input power for all the channels computed based on the relational expression, and the GSNRs for all the channels when the incoming OSNR is uniform.

5. A calculation method, comprising:
calculating input power to an optical fiber transmission line of each channel in two adjacent bands,
wherein the calculating calculates the input power for eliminating an inclination of signal quality by using a coefficient indicating an inclination of an input power spectrum by assuming that power transition in the transmission line due to an influence of stimulated Raman scattering depends on a number of existing channels in the optical fiber transmission line.

6. A non-transitory computer-readable medium storing a computer program causing a computer to function as the calculation device according to claim 1.

7. A non-transitory computer-readable medium storing a computer program causing a computer to perform the method of claim 5.
